(19) United States
(12) Patent Application Publication
(10) Pub. No.: US 2006/0198929 A1
(43) Pub. Date: Sep. 7, 2006

(54) Cream puff and its manufacturing method

(76) Inventor: Yuji Hirota, Osaka-shi (JP)

Correspondence Address: PITNEY HARDIN LLP, 7 TIMES SQUARE, NEW YORK, NY, 10036-7311, US

(21) Appl. No.: 11/073,291

(22) Filed: Mar. 4, 2005

(51) Int. Cl. A21D 13/00

(52) U.S. Cl. 426/94

(57) ABSTRACT

The composition of the outer skin of a cream puff is disclosed, which comprises a cream custard layer and a pie layer, and is characterized by a double-layer composition in which said cream custard layer is wrapped in said pie layer. The composition of the outer skin of a cream puff further comprises pieces of rod-shaped solid margarine for improvements in crunchy feeling of the cream puff when eaten, because those pieces create bubbles in the outer skin even after baking process. The addition of the pieces of rod-shaped margarine to the pie mixture prevents as a kind of adhesive property the outer skin from falling apart when eaten.

### BACKGROUND OF THE INVENTION

This invention relates to an improvement in of the outer skin or pie-crust layer of cream puffs. Specifically, this invention relates to the composition of the outer skin of a cream puff with a double-layer composition that is semi-processed goods used for the production of cream puffs.

A cream puff has the composition of cream custard filling in a pouch-shaped outer skin called a pie-rust. The inventor of this invention proposed such two-layered cream puff as described and shown in Japanese Utility Model Registration No. 3,086,215 issued on Mar. 13, 20022. The method of manufacturing such a two-layered cream puff includes a process to make a pie crust layer, that is a pouch-shaped skin, and a process to fill the pie crust with custard cream.

In further detail, such a cream puff is manufactured in the following processes.

Step I: Put a fixed amount of butter and water in a pot and heat it. Turn off the heat after boiling. Put in a fixed amount of flour and mix.

Step II: While stirring it, heat it again. Mix well.

Step III: After it is no longer hot, gradually add eggs that were beaten in advance to make the custard mixture.

Step IV: Squeeze out the mixture obtained by the Step III to a fixed size by using a squeezing bag.

Step V: Bake the custard mixture squeezed out to a fixed size in Step IV in the oven to obtain a pouch-shaped hollow pie crust.

Step VI: Cool the pie crust obtained in Step V, and then fill it with cream custard.

The resulting two-layered cream puff offers uniqueness of taste, mixed soft and crunchy feeling of eating. However, the outer skin or pie-crust layer of the double-layered cream puff falls apart easily when eaten. More crunchy feeling of the outer skin layer is more desirable for customers.

As a result, the outer skin layer of the double layered cream puff that does not fall apart but give crunchy feeling to the customers is needed.

### SUMMARY OF THE INVENTION

The object of this invention is to solve such problems by providing additionally pieces of rod-shaped margarine to a pie mixture or the outer skin of a cream puff.

The composition of the outer skin of a cream puff according to this invention further comprises pieces of rod-shaped solid margarine for improvements in crunchy feeling of the cream puff when eaten, because those pieces create bubbles in the outer skin even after baking process. The addition of the pieces of rod-shaped margarine to the pie mixture prevents as a kind of adhesive property the outer skin from falling apart when eaten.

As described above, the composition of the outer skin of a cream puff comprises a cream custard layer and a pie layer, and is characterized by a double-layer composition in which said cream custard layer is wrapped in said pie layer. It is preferable that said cream custard layer and pie layer are frozen.

It is also preferable that said pie crust layer has a missing section.

### BRIEF DESCRIPTION OF THE DRAWINGS

FIG. 1 is a perspective view showing the concept of a machine used for the production of pie and custard mixture.

FIG. 2(a) is a top view showing an example of the composition of the pie and custard in connection with working examples of this invention; FIG. 2(b) is a X-X line sectional view of the pie and custard mixture shown in FIG. 2(a).

FIG. 3(a) is an oblique view of the outer skin of a pie cream puff obtained by baking pie and custard mixture, and FIG. 3(b) is a vertical sectional view of FIG. 3(a) above.

### DETAILED DESCRIPTION OF THE INVENTION

### Working Examples of the Invention

We will describe the composition of the outer skin of a cream puff according to this invention (hereinafter referred to as “pie and custard mixture”) in detail below by referring to the attached drawings.

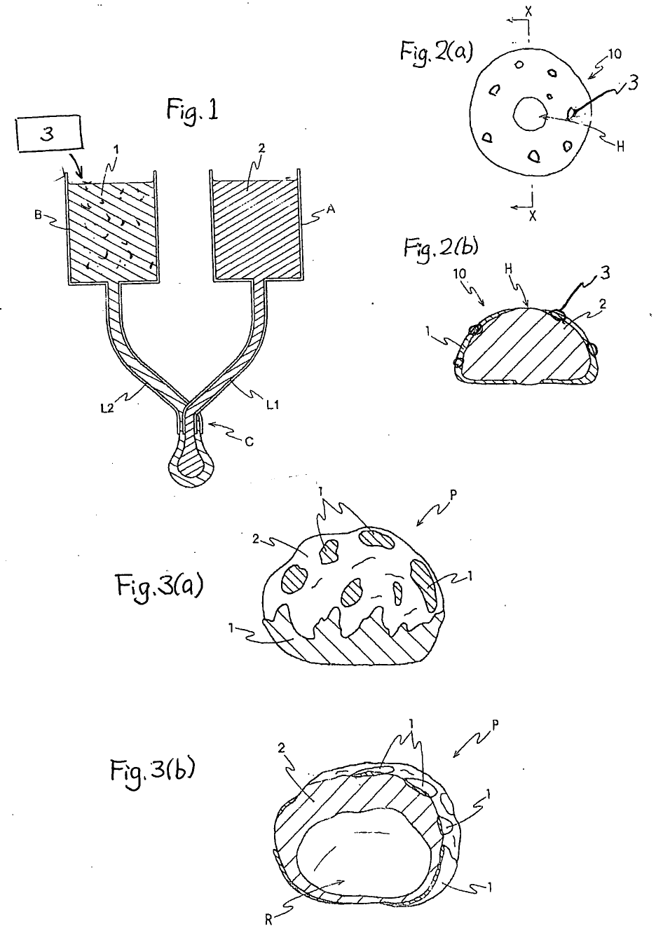

FIG. 1 is a perspective view showing the concept of a machine used for the production of pie and custard; FIG. 2(a) is a top view showing an example of the composition of pie and custard in connection with working examples of this invention; FIG. 2(b) is an X-X line sectional view of the pie and custard mixture as shown in FIG. 2(a); FIG. 3(a) is an oblique view of the outer skin of a cream puff obtained by baking pie and custard mixture; and FIG. 3(b) is a vertical sectional view of FIG. 3(a).

FIG. 2 (a) is a top view of the pie and custard mixture 10 and is in connection with working examples of this invention. FIG. 2 (b) is an X-X line sectional view of the pie and custard mixture. As shown in FIG. 2(b), the top section of the outer skin of the pie and custard mixture 10 is missing. This missing section is to make a pie and custard outer skin (external covering) P (See FIG. 3) by baking the pie and custard mixture 10 layer as well as to allow its expansion during the baking process.

As shown in FIG. 2(a) and 2(b), the pie and custard mixture 10, which is in connection with working examples of this invention, comprises the cream custard layer 2 and the pie layer 1, and has a double-layer composition in which the cream custard layer 2 is wrapped in the pie-crust layer 1.

The pie and custard mixture 10, which is in connection with working examples of this invention, is manufactured by using a manufacturing apparatus called a bean jam wrapping machine. Its conceptual view is shown in FIG. 1. The bean jam wrapping machine is exactly what it sounds like; it is well known in the culinary arts and has been used for the production of Japanese-style confections that have a composition of bean jam filled rice cake. This machine, however, has never been used for the production of a cream puff as used in this invention.

As shown in FIG. 1, the custard mixture 2 is contained in the custard mixture tank A, and the pie mixture 1 is in the pie mixture tank B.

The custard mixture 2 is brought down to the converging section C from the custard mixture tank A via the custard mixture pipe L1, and the pie mixture 1 is to the converging section C from the pie mixture tank B via the pie mixture pipe L2.

At the converging section C, the diameter of the pie mixture pipe L2 is larger than that of the custard mixture pipe L1. In other words, the tip of the custard mixture pipe L1 is inserted into the tip of the pie mixture pipe L2 at the converging section C.

At the converging section C, fixed amounts of custard mixture 2 and pie mixture 1 converge at fixed intervals. Then the mixture is dropped onto the belt conveyer (not shown here) to be transported to the next process, where the mixture is frozen until as the need arises to obtain the pie and custard mixture 10.

The freezing process of the pie and custard mixture 10 makes it possible to manufacture and sell the raw material for a cream puff outer skin P (See FIG. 3), as semi-processed goods. However, it is also possible to go through all the manufacturing processes starting from manufacturing the pie and custard mixture 10 to making the cream puff outer skin P (See FIG. 3) by baking the pie and custard mixture 10 in one manufacturing line just as in the above-mentioned conventional manufacturing method.

Finally, FIG. 3(b) is a vertical sectional view of a pie and custard skin (a cream puff outer skin) P obtained by baking the pie and custard mixture 10, which is in connection with working examples of this invention. The hollow section R shown in FIG. 3(b), is formed inside the pie and custard outer skin P and baked at a store. A cream puff is completed by filling cream such as custard cream containing natural vanilla beans in the hollow section R at a storefront.

Next, we will describe the raw materials for the custard and pie mixture and major components of the pie and custard composition in this invention.

### EXAMPLES

We will describe this invention in detail based in a working example below. This invention, however, is not limited to this example.

### Example 1

Pie Mixture 1

| | | | |
|---|---|---|---|
| (Ingredients) | Water | 5500 | g |
| | Wheat flour | | |
| | Enriched flour | 6000 | g |
| | Unenriched flour | 4000 | g |
| | Salt | 80 | g |
| | Chicken eggs (whole egg) | 1100 | g |
| | Euro malt | 200 | g |
| | Liquid margarine | 500 | g |
| | Solid margarine | 7000 | g |

(How to Make the Pie Mixture)

Put water, wheat flour, salt, chicken eggs, Euro malt, and liquid margarine in a bowl with a capacity of 90 quarts and mix them with a blender for 10 minutes. Put the mixture in a container (a Banzyu vat) and put it in the refrigerator at 5□ over night to make the primary pie mixture.

After preparation of the pie mixture 1, rod-like margarine is produced through the above mentioned beam jam wrapping machine. Starting material of margarine is squeezed into each of rod-shaped pieces 3 of solid margarine with 6 mm of diameter and 2 cm of length through the beam jam wrapping machine. The resulting pieces of the rod-shaped margarine are held at a refrigerator and the production of cylindrical margarine pierces is completed. This process makes ready for preparation of pie secondary mixture.

Put the primary pie mixture back in the bowl and mix it with a mixer for 9 minutes. After 9 minutes, the rod-shaped pieces 3 of solid margarine are added to the primary pie mixture. Mix the primary pie mixture together with the rod-shaped margarine pieces for 65-80 seconds. Put this pie mixture back in the container (a Banzyu vat).

Cream Custard Mixture 2

| | | | |
|---|---|---|---|
| (Ingredients) | Salt-free butter | 4150 | g |
| | Water | 8259 | g |
| | Salt | 80 | g |
| | Wheat flour | | |
| | Enriched flour | 2500 | g |
| | Unenriched flour | 2500 | g |
| | Chicken eggs (whole egg) | 9300 | g |
| | Baking soda | 30 | g |
| | Ammonia | 40 | g |

(How to Make the Custard Mixture)

Put the salt-free butter, water, and salt in a bowl with a capacity of 50 quarts and heat the contents to the boiling point. After reaching the boiling point, turn off the heat. Add wheat flour and mix the contents. Put it in a mixer and put it on the cooking stove, then start the mixer. After two minutes, lower the temperature of the cooking stove while keeping the mixer in motion. After three minutes, turn off the cooking stove. Stop the mixer after one minute.

Next, start the mixer again and add half of the chicken eggs slowly. Add half of the remaining chicken eggs after one minute. Stop the mixer after four minutes.

Start the mixer again. Add a mixture of the remaining chicken eggs, ammonia, and baking soda that were mixed in advance for one minute by using an eggbeater. After three minutes, stop the mixer. Put the mixture thus obtained into a container (a Banzyu vat) and place the container in the refrigerator (5□) to quickly cool it down. Keep it in the refrigerator for about 5 to 24 hours.

Cream Puff

(How to Make Pie and Custard Mixture)

Put custard mixture and pie mixture in CN 130 Martian of Rheon Automatic Machinery Co., Ltd. and set the machine in motion to obtain the pie and custard mixture (a diameter of about 3 cm and about 4 mm in thickness) that has a double-layer composition as shown in FIGS. 2(a) and 2(b) by surrounding the custard mixture with the pie mixture. Place 104 pieces of the pie and custard mixture thus obtained side by side on an iron tray and place the iron tray on a rack. Put the rack in the refrigerator to cool it down for about 5 to 9 hours. Place 208 pieces (for 2 iron trays) in a bag. Stuff the bag in a box and preserve it in the freezer.

(How to Make a Cream Puff)

Naturally defrost the pie and custard mixture and bake it in the oven at about 180□ for about 25 minutes. Take it out of the oven. Thus the external covering (outer skin) of the cream puff is obtained as shown in FIGS. 3(a) and 3(b).

Pour custard cream containing natural vanilla beans through a nozzle to obtain a cream puff.

By adding the pieces of rod-shaped margarine to the primary pie mixture, fat portions of the sliced pieces of rod-shaped margarine are mixed uniformly with the primary pie mixture and expanded equally during baking process. The pie crust layer with bubbles resulting from the sliced pieces of the rod-shaped margarine after baking process offers more crunchy feeling to the customers. The pieces of rod-shaped margarine attached to the pie layer serve as adhesive between the pie crust layer and the cream custard layer so that the outer skin does not fall easily apart when eaten.

The outer skin of a cream puff according to this invention comprises the cream custard layer and the pie crust layer, and has a double-layer composition in which said cream custard layer is wrapped in said pie layer; and therefore the outer skin (external covering) mixture of a cream puff has a composition that can function as custard. Furthermore, since it has nearly the same viscosity as that of bean jam, it is possible to manufacture a large amount of pie and custard mixture by using a bean jam wrapping machine.

The outer skin of a cream puff according to this invention comprises the cream custard layer and the pie layer, and has a double-layer composition in which said cream custard layer is wrapped in said pie layer; and both said cream custard layer and said pie layer are frozen. Therefore, it is possible to manufacture and sell the outer skin of a cream puff as semi-processed goods.

The expansion of the mixture can be allowed during the baling process because of a missing section of the pie layer. This is the featured composition of the outer skin according to this invention.

What is claimed is:

1. A cream puff comprising a cream custard layer and a pie crust layer, the pie crust layer further comprising pieces of rod-shaped margarine.

2. A cream puff filled with cream in pouch-shaped pie and custard mixture comprising a cream custard layer and a pie crust layer, the pie crust layer comprising primary pie mixture and pieces of rod-shaped margarine.

3. A method for manufacturing a cream puff of double-layered structure having a cream custard layer and a pie crust layer, said method comprising the steps of:
preparing a cream custard mixture for the cream custard layer;
preparing a pie mixture for the pie crust layer;
adding sliced pieces of rod-shaped margarine to the pie mixture;
mixing the cream custard mixture and the pie mixture with the pieces of rod-shaped margarine; and
baking the mixture to complete production of the cream puff.

4. The cream puff of claim 1 wherein the pie mixture comprises water, wheat flour, enriched flour, unenriched flour, salt, chicken eggs, Euro malt, liquid margarine and solid margarine.

5. The cream puff of claim 1 wherein the cream custard mixture comprises salt-free butter, water, salt, wheat flour, enriched flour, unenriched flour, chicken eggs, baking soda, and ammonia.
